(19) United States
(12) Patent Application Publication
(10) Pub. No.: US 2026/0005339 A1
(43) Pub. Date: Jan. 1, 2026

(54) POSITIVE ELECTRODES, PREPARATION METHODS THEREOF, AND RECHARGEABLE LITHIUM BATTERIES

(71) Applicant: SAMSUNG SDI CO., LTD., Yongin-si (KR)

(72) Inventors: Seunghyun JEON, Yongin-si (KR); Seung-Hun HAN, Yongin-si (KR); Youngkwang CHO, Yongin-si (KR); Hyunwoo KIM, Yongin-si (KR); Moonju CHO, Yongin-si (KR); Seunghyun LIM, Yongin-si (KR)

(73) Assignee: SAMSUNG SDI CO., LTD., Yongin-si (KR)

(21) Appl. No.: 19/244,145

(22) Filed: Jun. 20, 2025

(30) Foreign Application Priority Data
Jun. 26, 2024 (KR) 10-2024-0083929

(51) Int. Cl. H01M 10/659; H01M 4/02; H01M 4/04; H01M 4/36; H01M 4/58; H01M 4/62; H01M 10/0525

(52) U.S. Cl. CPC H01M 10/659; H01M 4/0404; H01M 4/366; H01M 4/5825; H01M 4/623; H01M 4/628; H01M 10/0525; H01M 2004/021; H01M 2004/028

(57) ABSTRACT

Disclosed are a positive electrode, a method of preparing the positive electrode, and a rechargeable lithium battery including the positive electrode. The positive electrode includes a positive electrode current collector, a positive electrode active material layer on the positive electrode current collector, and a coating layer between the positive electrode current collector and the positive electrode active material layer. The coating layer includes lithium metal phosphate, boron nitride, and boehmite.

### CROSS-REFERENCE TO RELATED APPLICATION

This application claims priority to Korean Patent Application No. 10-2024-0083929 filed in the Korean Intellectual Property Office on Jun. 26, 2024, the entire contents of which are incorporated herein by reference.

### BACKGROUND

### 1. Field

Positive electrodes, preparation methods thereof, and rechargeable lithium batteries including the positive electrodes are disclosed.

### 2. Description of the Related Art

A portable information device such as, e.g., a cell phone, a laptop, smart phone, and the like, or an electric vehicle, typically uses a rechargeable lithium battery having high energy density and portability as a driving power source. Rechargeable lithium batteries with high energy density as a driving power source or power storage power source for hybrid or electric vehicles may be advantageous.

Rechargeable lithium batteries typically include a positive electrode and a negative electrode including an active material capable of intercalating and deintercalating lithium ions, and an electrolyte solution, and electrical energy is produced through oxidation and reduction reactions when lithium ions are intercalated and deintercalated from the positive electrode and negative electrode.

Transition metal compounds such as lithium cobalt-based oxide, lithium nickel-based oxide, and lithium manganese-based oxide are typically used as positive electrode active materials for rechargeable lithium batteries, and crystalline carbon materials such as natural graphite or artificial graphite or amorphous carbon materials are typically used as negative electrode active materials.

### SUMMARY

Some example embodiments include a positive electrode capable of ensuring safety by reducing or suppressing ignition and thermal runaway of the battery when a nail is penetrated, while securing high energy density and desired or improved capacity characteristics, a method for preparing the same, and a rechargeable lithium battery.

Some example embodiments include a positive electrode including a positive electrode current collector, a positive electrode active material layer on the positive electrode current collector, and a coating layer between the positive electrode current collector and the positive electrode active material layer, wherein the coating layer includes lithium metal phosphate, boron nitride, and boehmite.

Some example embodiments include a method for preparing a positive electrode, which includes coating a slurry for forming a coating layer including lithium metal phosphate, boron nitride, and boehmite on a positive electrode current collector and drying the slurry to form a coating layer, and forming a positive electrode active material layer on the coating layer.

Some example embodiments include a rechargeable lithium battery including the aforementioned positive electrode, a negative electrode, and an electrolyte.

According to some example embodiments, a positive electrode and a method for preparing the positive electrode, and a rechargeable lithium battery can be provided, which help secure safety by reducing or suppressing ignition and thermal runaway of the battery when, e.g., a nail is penetrated, while helping to secure high energy density and desired or improved capacity characteristics.

### BRIEF DESCRIPTION OF THE DRAWINGS

FIGS. 1 to 4 are cross-sectional views schematically illustrating a rechargeable lithium battery according to some example embodiments.

FIG. 5 shows the results of measuring the plate resistance of the positive electrodes manufactured in Examples 1 to 3 and Comparative Examples 1 and 2.

FIG. 6 is a flow chart illustrating a method for preparing a positive electrode, according to an example embodiment.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, the element can be directly on the other element, or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope (TEM) image or a scanning electron microscope (SEM) image. Alternatively, it is possible to obtain an average particle diameter value by using a dynamic light scattering method, performing data analysis, counting the number of particles for each particle size range, and calculating from this method. Unless otherwise defined, the average particle diameter may indicate the diameter (D50) of particles having a cumulative volume of 50 volume % in the particle size distribution. As used herein, when a definition is not otherwise provided, the average particle diameter indicates a diameter (D50) of particles having a cumulative volume of 50 volume % in the particle size distribution that is obtained by measuring the size (diameter or major axis length) of about 20 particles at random in a scanning electron microscope image.

Herein, the term “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Positive Electrode

In some example embodiments, a positive electrode includes a positive electrode current collector, a positive electrode active material layer on the positive electrode current collector, and a coating layer between the positive electrode current collector and the positive electrode active material layer, wherein the coating layer includes lithium metal phosphate, boron nitride, and boehmite.

A rechargeable lithium battery is typically the most widely used energy storage device due to high energy density, desired or improved power characteristics, high charge and discharge efficiency, and stable cycle-life characteristics. Recently, with the development of the electric vehicle industry, rechargeable batteries capable of exhibiting higher energy density and power characteristics are advantageous.

However, the improvement of energy density and power characteristics of rechargeable batteries entails a potential problem of deteriorating battery safety by increasing a risk of short-circuits and fires caused by internal and external factors. Due to this ignition issue of the rechargeable lithium battery, safety is increasingly relevant and in particular, highly advantageous in applying small pouch batteries for virtual reality (VR) devices, smart phones, and the like, that come into close contact with a human body.

For the purpose of improving a nail penetration evaluation of penetrating a battery with a thin pin, which is one of the safety evaluation items, the technology of forming a coating layer serving as a safety functional layer between positive electrode current collector and positive electrode active material layer is being developed.

However, a conventional coating layer has disadvantages in that the conventional coating layer typically has to be coated to be very thick to secure the safety effect by serving a safety functional layer, wherein the thicker coating layer, the more disadvantageous to secure energy density of the battery due to low usage of lithium metal phosphate in a positive electrode and low mixture density.

Accordingly, some example embodiments introduce a coating layer using boehmite and boron nitride with desired or improved flexibility and heat-absorbing effect together as well as high thermal and chemical safety into the positive electrode to reduce exothermicity, even when the safety functional layer is thin, and thus secure thermal safety, and as a result provide a positive electrode capable of ensuring desired or improved energy density.

The positive electrode includes a positive electrode current collector, and a positive electrode active material layer on the positive electrode current collector. Herein, aluminum (Al), stainless steel (SUS), or a combination thereof may be used as the positive electrode current collector, but is not limited thereto.

### Coating Layer (or, Positive Electrode Coating Layer)

The positive electrode is disposed between the positive electrode current collector and the positive electrode active material layer, and includes a coating layer including lithium metal phosphate, boron nitride, and boehmite.

According to some example embodiments, by mixing and adding boron nitride having heat-absorbing and elongation properties and boehmite having heat-absorbing properties and acting as a resistor to the coating layer, a desired level of resistance can be secured even at a low loading level, thereby enabling the layer to function as a safety functional layer, while increasing a mixture density to secure a high energy density. Through this, the coating layer can effectively function as a safety functional layer in the event of ignition or nail penetration due to an abnormal temperature rise, thereby reducing heat generation within the battery and ensuring thermal and chemical stability.

For example, the boron nitride may be or include hexagonal boron nitride (h-BN).

When boron nitride is hexagonal boron nitride, the coating layer can perform the role of a safety functional layer by absorbing heat in the event of an abnormal temperature rise or nail penetration, and can also be advantageous in securing the desired resistance level and high energy density.

In some example embodiments, the lithium metal phosphate may include one or more of the compounds represented by Chemical Formulas 1 to 5.

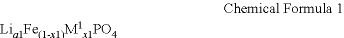

In Chemical Formula 1, 0.90≤a1≤1.5, 0≤x1≤0.4, and M¹ is or includes at least one of Al, Ca, Ce, Cr, Cu, La, Mg, Mn, Mo, Nb, Ni, Sn, Sr, Ti, V, W, Y, Zn, Zr, or a combination thereof. Herein, 0.90≤a1≤1.5, for example 0.90≤a1≤1.2, or 0.95≤a1≤1.1. Additionally, 0≤x1≤0.4, 0≤x1≤0.3,0≤x1≤0.2, 0≤x1≤0.1, or 0≤x1≤0.05.

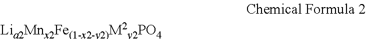

In Chemical Formula 2, 0.90≤a2≤1.5, 0.1≤x2≤0.9, 0≤y2≤0.9, and M² is or includes at least one of Al, Ca, Ce, Cr, Cu, La, Mg, Mo, Nb, Ni, Sn, Sr, Ti, V, W, Y, Zn, Zr, or a combination thereof. Herein, 0.90≤a2≤1.5, for example 0.90≤a2≤1.2, or 0.95≤a2≤1.1. Additionally, 0.1≤x2≤0.9, 0.3≤x2≤0.9, or 0.4≤x2≤0.8, and 0≤y2≤0.4, 0≤y2≤0.3, 0≤y2≤0.2, 0≤y2≤0.1, or 0≤y2≤0.05.

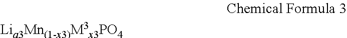

In Chemical Formula 3, 0.90≤a3≤1.5, 0≤x3≤0.4, and M³ is or includes at least one of Al, Ca, Ce, Cr, Cu, La, Mg, Mo, Nb, Ni, Sn, Sr, Ti, V, W, Y, Zn, Zr, or a combination thereof. Herein, 0.90≤a3≤1.5, for example 0.90≤a3≤1.2, or 0.95≤a3≤1.1. Additionally, 0≤x3≤0.4, 0≤x3≤0.3, 0≤x3≤0.2, 0≤x3≤0.1, or 0≤x3≤0.05.

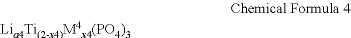

In Chemical Formula 4, 0.90≤a4≤1.5, 0≤x4≤0.4, and M⁴ is or includes at least one of Al, Ca, Ce, Cr, Cu, La, Mg, Mo, Nb, Ni, Sn, Sr, V, W, Y, Zn, Zr, or a combination thereof. Herein, 0.90≤a4≤1.5, for example 0.90≤a4≤1.2, or 0.95≤a4≤1.1. Additionally, 0≤x4≤0.4, 0≤x4≤0.3, 0≤x4≤0.2, 0≤x4≤0.1, or 0≤x4≤0.05.

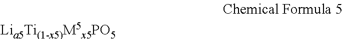

In Chemical Formula 5, 0.90≤a5≤1.5, 0≤x5≤0.4, and M⁵ is or includes at least one of Al, Ca, Ce, Cr, Cu, La, Mg, Mo, Nb, Ni, Sn, Sr, V, W, Y, Zn, Zr, or a combination thereof. Herein, 0.90≤a5≤1.5, for example 0.90≤a5≤1.2, or 0.95≤a5≤1.1. Additionally, 0≤x5≤0.4, 0≤x5≤0.3,0≤x5≤0.2, 0≤x5≤0.1, or 0≤x5≤0.05.

For example, the lithium metal phosphate may be or include a lithium transition metal phosphate, and for example, the lithium metal phosphate may include at least one of LifePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, LiMnPO₄, LiTiPO₅, LiTi₂(PO₄)₃, or a combination thereof. As an example, the positive electrode active material may include at least one of lithium iron phosphate, lithium manganese iron phosphate, or a combination thereof, and may include, for example, at least one of a compound represented by Chemical Formula 1, a compound represented by Chemical Formula 2, or a combination thereof. This positive electrode active material can secure cost reduction and safety effects and realize high power characteristics, and when combined with a binder according to some example embodiments, the positive electrode active material can increase the energy density of the positive electrode and improve the adhesiveness and flexibility of the electrode plate.

The lithium metal phosphate is in the form of particles, and the average particle diameter (D50) of the particles may be in a range of about 0.01 μm to about 2 μm, for example, about 0.1 μm to about 1 μm, or about 0.2 μm to about 0.9 μm.

In some example embodiments, the lithium metal phosphate may be in the form of first particles, second particles, or a mixture of first particles and second particles.

The first particles may be an assembly of a plurality of nano-sized primary particles or secondary particles. The first particles may have a spherical or elliptical shape as the primary particles are closely agglomerated with each other. The average particle diameter of the first particles may be in a range of, for example, about 2 μm to about 15 μm, about 3 μm to about 12 μm, or about 3 μm to about 10 μm. The average particle diameter of the first particles may be larger than the average particle diameter of the second particles, which is described below. The average particle diameter of the primary particles of the first particles may be, for example, in a range of about 10 nm to about 400 nm, about 20 nm to about 300 nm, or about 50 nm to about 200 nm. As an example, the average particle diameter of the first particles may be measured by selecting, e.g., randomly selecting, about 30 first particles from an electron microscope image of lithium metal phosphate, and in the particle size distribution, the diameter (D50) of particles with a cumulative volume of 50% by volume may be taken as the average particle diameter. The average particle diameter of the primary particles of the first particle may be determined by measuring the size of about 30 primary particles in an electron microscope image of the surface or cross-section of the first particle and in the particle size distribution, the diameter (D50) of particles with a cumulative volume of 50 volume % may be taken as the average particle diameter.

The porosity of the first particles may be in a range of about 20% to about 50%. As an example, the porosity may be obtained by measuring the area ratio of the portion occupied by pores within the particle using an image analysis program such as Image J in a scanning electron microscope image of the cross-section of the first particle.

The second particle may have the form of a single particle. The average particle diameter of the second particles may be, for example, in a range of about 10 nm to about 900 nm, about 50 nm to about 500 nm, or about 100 nm to about 300 nm. The average particle diameter of the second particles may be smaller than the average particle diameter of the first particles, and may be equal to or larger than the average particle diameter of the primary particles of the first particles. As an example, the average particle diameter of the second particles may be measured by selecting, e.g., randomly selecting, about 30 second particles from an electron microscope image of lithium metal phosphate, and in the particle size distribution, the diameter (D50) of particles with a cumulative volume of 50% by volume may be taken as the average particle diameter.

The lithium metal phosphate may further include a carbon coating layer on the surface of the particle. The carbon coating layer can lower the resistance of the positive electrode by improving the electrical conductivity of the lithium metal phosphate. The carbon coating layer may be formed, for example, using at least one raw material such as or including at least one of glucose, sucrose, lactose, starch, oligosaccharide, polyoligosaccharide, fructose, cellulose, a polymer of furfuryl alcohol, a block copolymer of ethylene and ethylene oxide, a vinyl resin, a cellulose resin, a phenol resin, a pitch-based resin, and a tar-based resin. For example, the carbon coating layer may be formed through a sintering process after placing the raw materials on the surface of the lithium metal phosphate particles.

For example, the lithium metal phosphate may be included in an amount in a range of about 70 wt % to about 98 wt %, for example, about 75 wt % to about 95 wt %, or about 80 wt % to about 90 wt % based on 100 wt % of the coating layer. Within this range, it is possible to reduce or prevent deterioration of capacity characteristics or cycle-life characteristics during normal times and secure desired or improved energy density.

For example, the boron nitride may be included in an amount in a range of about 0.5 wt % to about 10 wt %, for example, about 1 wt % to about 10 wt % or about 5 wt % to about 9 wt % based on 100 wt % of the coating layer. Within this range, the effect of securing a desired level of resistance and securing desired or improved energy density can be improved by adding boron nitride into the coating layer.

In some example embodiments, the boehmite may be included in an amount in a range of about 0.5 wt % to about 10 wt %, for example, about 1 wt % to about 9 wt % or about 1 wt % to about 5 wt %, based on 100 wt % of the coating layer. Within this range, the effect of securing a desired level of resistance and securing desired or improved energy density can be improved by adding boehmite into the coating layer.

For example, the total content of the boron nitride and the boehmite may be in a range of about 1 wt % to about 20 wt %, for example about 5 wt % to about 15 wt %, or about 6 wt % to about 10 wt %, based on 100 wt % of the coating layer. Within this range, the effects of adding boron nitride and boehmite in the coating layer can be harmonized, which can be advantageous in securing the desired level of resistance and desired or improved energy density.

In some example embodiments, the coating layer may further include a binder. In the coating layer, the binder can play a role in ensuring that the components within the layers adhere to each other and to the adjacent layers, e.g., the positive electrode current collector and the positive electrode active material layer.

For example, the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, polyester resin, nylon, or combinations thereof, but is not limited thereto.

For example, the binder included in the coating layer may include a fluorine-based binder, and for example, the binder used in the coating layer may include at least one of polytetrafluoroethylene, polyvinylidene fluoride (PVdF), or a combination thereof. In this way, by using such a fluorine-based binder in the coating layer, the effect of the binder addition can be harmoniously exerted without inhibiting the effect of the addition of lithium metal phosphate, boron nitride, and boehmite in the coating layer.

For example, the coating layer may include the binder in an amount in a range of about 1 wt % to about 10 wt %, for example, about 3 wt % to about 9 wt %, or about 5 wt % to about 8 wt %, based on 100 wt % of the coating layer. Within this range, the effects of addition of lithium metal phosphate, boron nitride, and boehmite within the coating layer can be reduced or prevented from being impaired, while each component can be adhered to the components within the coating layer or the coating layer can be attached between adjacent layers.

For example, the coating layer may include about 10 wt % to about 90 wt % of the boron nitride, for example about 30 wt % to about 90 wt %, about 40 wt % to about 90 wt %, about 50 wt % to about 90 wt %, or about 70 wt % to about 90 wt % based on 100 wt % of the total of the boron nitride and the boehmite. The effects of adding boron nitride and boehmite to the coating layer can be harmonized, which can be advantageous in securing the desired level of resistance and desired or improved energy density.

For example, the coating layer may include about 10 wt % to about 90 wt %, for example, about 10 wt % to about 70 wt %, about 10 wt % to about 60 wt %, about 10 wt % to about 50 wt %, or about 10 wt % to about 30 wt % of the boehmite based on 100 wt % of the total of the boron nitride and the boehmite. Within this range, the effects of adding boron nitride and boehmite in the coating layer can be harmonized, which can be advantageous in securing the desired level of resistance and desired or improved energy density.

In some example embodiments, the boron nitride and the boehmite may be in particle form, and an average particle diameter (D50) of the boehmite may be smaller than the average particle diameter (D50) of the boron nitride. When the average particle diameter of the boehmite is smaller than the average particle diameter of the boron nitride, the effects of adding the above boron nitride and the above boehmite can be harmonized with each other.

For example, the average particle diameter (D50) of the boron nitride may be in a range of about 5 μm to about 20 μm, for example about 5 μm to about 10 μm, or about 6 μm to about 9 μm. Within this range, the effect of securing a desired level of resistance and securing desired or improved energy density can be improved by adding boron nitride into the coating layer.

For example, the average particle diameter (D50) of the boehmite may be in a range of about 0.5 μm to about 4 μm, for example about 0.5 μm to about 3 μm, or about 1 μm to about 3 μm. Within this range, the effect of securing a desired level of resistance and securing desired or improved energy density can be improved by adding boehmite into the coating layer.

In some example embodiments, the boron nitride and the boehmite may be in the form of particles, and an average particle diameter (D50) of the boron nitride may be in the range of about 1.25 to about 20 times, for example, about 1.5 times to about 10 times, about 2 times to about 5 times, or about 3 times to about 4 times the average particle diameter (D50) of the boehmite. Within this range, the effects of adding boron nitride and boehmite in the coating layer can be harmonized, which can be advantageous in securing the desired level of resistance and desired or improved energy density.

Herein, the average particle diameter (D50) of boron nitride and boehmite may be, for example measured by an electron microscope, such as a scanning electron microscope, on a cross-section or surface of the coating layer. For example, a particle size distribution may be obtained by measuring, e.g., randomly measuring, the sizes (diameter or major axis length) of about 20 particles in a scanning electron microscope image, and the diameter (D50) of particles having a cumulative volume of 50 volume % in the particle size distribution may be taken as the average particle diameter.

For example, the thickness of the coating layer may be in a range of about 1 μm to about 30 μm, for example about 2 μm to about 20 μm, about 3 μm to about 15 μm, about 3 μm to about 10 μm, or about 5 μm to about 8 μm. Within this range, boron nitride and boehmite in the coating layer can reduce or suppress ignition by absorbing heat during nail penetration, and thermal and chemical safety can be secured. Through this, the coating layer can effectively function as a safety functional layer even with a thinner thickness than before, thereby securing safety while also reducing the loss of energy density. The thickness of the above coating layer may be measured, for example, via scanning electron microscopy of a cross-section of the positive electrode.

For example, the loading level of the coating layer may be in a range of about 1 mg/cm² to about 5 mg/cm².

For example, the composite density of the positive electrode coating layer may be greater than or equal to about 2.5 g/cc, for example, a range of about 2.5 g/cc to about 3.7 g/cc, or about 2.5 g/cc to about 3.5 g/cc.

### Positive Electrode Active Material Layer

In some example embodiments, the positive electrode active material layer may include at least one of a positive electrode active material, a binder, a conductive material, or a combination thereof.

The positive electrode active material may be or include a compound (lithiated intercalation compound) capable of intercalating and deintercalating lithium. For example, the positive electrode active material may be or include at least one of a composite oxide of lithium and a metal such as or including at least one of cobalt, manganese, nickel, and combinations thereof.

The composite oxide may be or include a lithium metal composite oxide, and examples thereof may include at least one of lithium nickel-based oxide, lithium cobalt-based oxide, lithium manganese-based oxide, lithium iron phosphate, cobalt-free lithium nickel-manganese-based oxide, lithium-manganese-rich oxide, or a combination thereof.

As another example, a compound represented by any one of the following chemical formulas may be used. LiaA_{1-b}XbO_{2-c}D_{c} (0.90≤a≤1.8, 0≤b≤0.5, 0≤c≤0.05); LiₐMn_{2-b}XbO_{4-c}D_{c} (0.90≤a≤1.8, 0≤b≤0.5, 0≤c≤0.05); LiₐNi_{1-b-c}Co_{b}X_{c}O₂₋ₐDₐ (0.90≤a≤1.8, 0≤b≤0.5, 0≤c≤0.5, 0≤a<2); LiₐNi_{1-b-c}Mn_{b}X_{c}O₂₋ₐDₐ (0.90≤a≤1.8, 0≤b≤0.5, 0≤c≤0.5, 0<a<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)} Fe₂(PO₄)₃ (0≤f≤2); LiₐFePO₄ (0.90≤a≤1.8)

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; Q is or includes at least one of Ti, Mo, Mn, or a combination thereof; Z is or includes at least one of Cr, V, Fe, Sc, Y, or a combination thereof; and L¹ is or includes at least one of Mn, Al or a combination thereof.

For example, the positive electrode active material may include a cobalt-based positive electrode active material having a cobalt content that is greater than or equal to about 30 mol %, greater than or equal to about 50 mol %, or greater than or equal to about 80 mol % based on100 mol % of metal excluding lithium in a lithium metal composite oxide.

As another example, the positive electrode active material may include a high-nickel positive electrode active material having a nickel content of greater than or equal to about 80 mol % based on 100 mol % of metal excluding lithium in a lithium metal composite oxide. A nickel content in the high-nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium. The high-nickel positive electrode active material can realize high capacity and can be applied to high-capacity, high-density rechargeable lithium batteries.

In the positive electrode active material layer, the binder is configured to attach positive electrode active material particles to each other and also to attach positive electrode active material to adjacent layers. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

In the positive electrode active material layer, the conductive material is included to provide electrode conductivity, and any electrically conductive material may be included as a conductive material unless the electrically conductive material causes a chemical change. Examples of the conductive material may include a carbon-based material such as or including at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

In the positive electrode active material layer, the contents of the binder and the conductive material may be in a range of about 0.5 wt % to about 5 wt %, respectively, based on 100 wt % of the positive electrode active material layer.

For example, the thickness of the positive electrode active material layer may be in a range of about 2 μm to about 60 μm, for example about 5 μm to about 55 μm, about 10 μm to about 50 μm, or about 20 μm to about 45 μm.

For example, the coating layer and the positive electrode active material layer have a thickness ratio in a range of about 1:2 to about 1:50. When this is satisfied, the coating layer may effectively absorb heat during the abnormal temperature rise or the nail penetration to be configured as a safety functional layer, while simultaneously or contemporaneously achieving the effect of securing capacity characteristics by a positive electrode active material layer.

### Method for Preparing Positive Electrode

In some example embodiments, a method for preparing a positive electrode includes coating a slurry for forming a coating layer including lithium metal phosphate, boron nitride, and boehmite on a positive electrode current collector and drying the slurry to form a coating layer, and forming a positive electrode active material layer on the coating layer.

The above description relates to a method of manufacturing the positive electrode according to some example embodiments, and hereinafter, any description overlapping with the above description of the positive electrode is omitted, but processes of manufacturing the positive electrode according to some example embodiments are described in detail.

First, a slurry for forming a coating layer including lithium metal phosphate, boron nitride, and boehmite is prepared. Herein, the above description may be equally applied to the lithium metal phosphate, the boron nitride, the boehmite, and the coating layer. Subsequently, the slurry for forming a coating layer is applied on the positive electrode current collector, and subsequently dried to form a coating layer.

For example, the method of applying the slurry for forming a coating layer may be performed by adopting a method generally known in the art. In addition, the drying may be performed in a convection oven at a temperature in a range of about 50° C. to about 200° C., for example, about 80° C. to about 150° C. or about 100° C. to about 120° C.

Subsequently, the method includes forming a positive electrode active material layer on the coating layer. The positive electrode active material layer may be performed by adopting a method generally known in the relevant technical field, and the above description may be equally applied to the positive electrode active material layer.

### Rechargeable Lithium Battery

Some example embodiments include a rechargeable lithium battery including the aforementioned positive electrode, negative electrode, and electrolyte. As an example, a rechargeable lithium battery may include a positive electrode, a negative electrode, a separator between the positive electrode and the negative electrode, and an electrolyte solution.

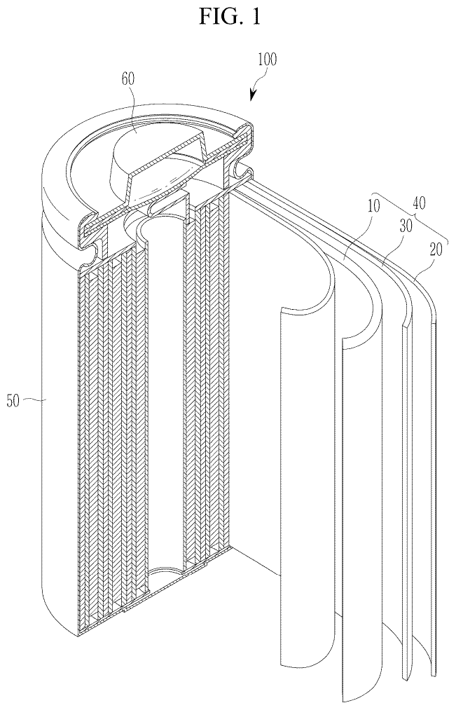

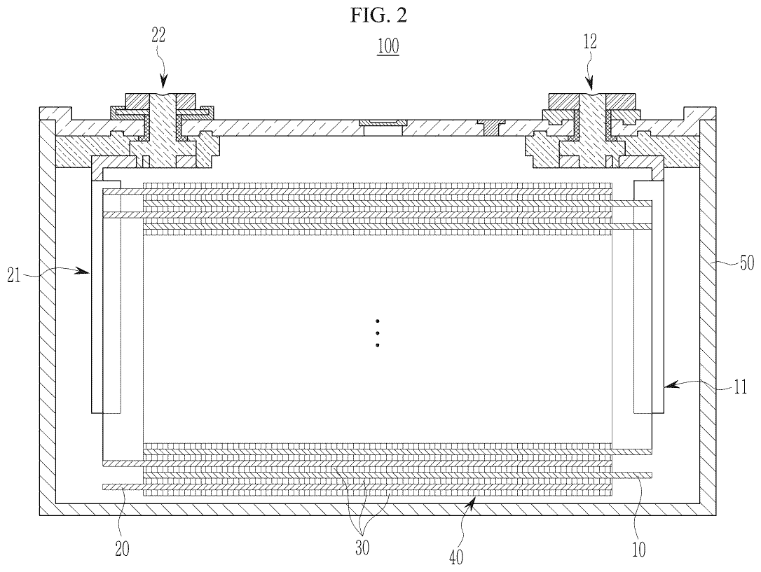

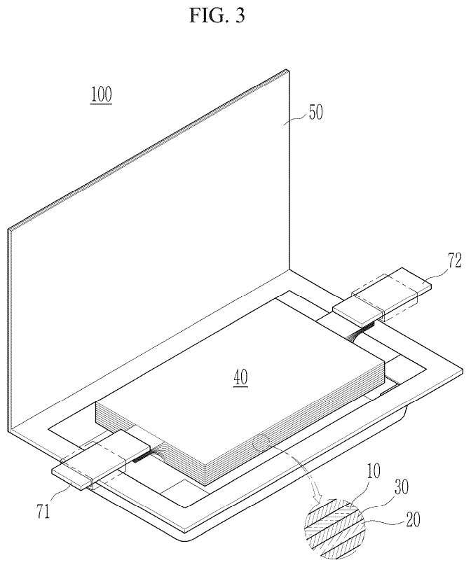

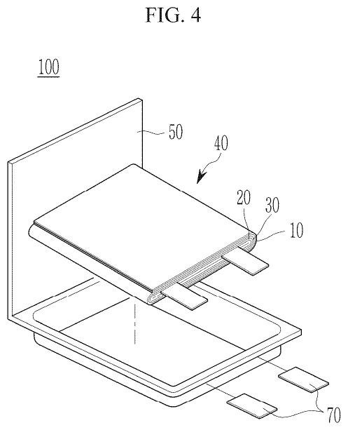

Rechargeable lithium batteries can be classified into cylindrical, square, pouch, and coin types depending on their shape. FIGS. 1 to 4 are schematic views illustrating a rechargeable lithium battery according to some example embodiments. FIG. 1 shows a cylindrical battery, FIG. 2 shows a prismatic battery, and FIGS. 3 and 4 show a pouch battery. Referring to FIGS. 1 to 4, the rechargeable lithium battery 100 may include an electrode assembly 40 with a separator 30 interposed between a positive electrode 10 and a negative electrode 20, and a case in which the electrode assembly 40 is housed therein. The positive electrode 10, negative electrode 20, and separator 30 may be impregnated with an electrolyte solution (not shown). The rechargeable lithium battery 100 may include a sealing member 60 that seals a battery case 50 as shown in FIG. 1. Additionally, in FIG. 2, the rechargeable lithium battery 100 may include a positive electrode lead tab 11, a positive electrode terminal 12, a negative electrode lead tab 21, and a negative electrode terminal 22. As shown in FIGS. 3 and 4, the rechargeable lithium battery 100 includes an electrode tab 70 illustrated in FIG. 4, such as a positive electrode tab 71 and a negative electrode tab 72 illustrated in FIG. 3, the electrode tabs 70/71/72 forming an electrical path for inducing the current formed in the electrode assembly 40 to the outside of the battery 100.

### Negative Electrode

The negative electrode may include a current collector, and a negative electrode active material layer on the current collector, wherein the negative electrode active material layer includes a negative electrode active material, and may further include a binder, a conductive material, or a combination thereof.

### Negative Electrode Active Material

The negative electrode active material includes at least one of a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si—Q alloy (wherein Q is an element including at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles and amorphous carbon coated on the surface of the silicon particles. For example, the silicon-carbon composite may include a secondary particle (core) in which silicon primary particles are assembled and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be artificial graphite, natural graphite, or a combination thereof. The amorphous carbon may include the silicon-carbon composite soft carbon or hard carbon, a mesophase pitch carbonized product, and calcined coke.

When the silicon-carbon composite includes silicon and amorphous carbon, a silicon content may be in a range of about 10 wt % to about 50 wt %, and a content of amorphous carbon may be in a range of about 50 wt % to about 90 wt % based on 100 wt % of the silicon-carbon composite. In addition, when the composite includes silicon, amorphous carbon, and crystalline carbon, a silicon content may be in a range of about 10 wt % to about 50 wt %, a content of crystalline carbon may be in a range of about 10 wt % to about 70 wt %, and a content of amorphous carbon may be in a range of about 20 wt % to about 40 wt % based on 100 wt % of the silicon-carbon composite.

Additionally, a thickness of the amorphous carbon coating layer may be in a range of about 5 nm to about 100 nm. An average particle diameter (D50) of the silicon particles (primary particles) may be in a range of about 10 nm to about 1 μm, or about 10 nm to about 200 nm. The silicon particles may be present as silicon alone, in the form of a silicon alloy, or in an oxidized form. The oxidized form of silicon may be represented by SiOₓ (0<x≤2). For example, the atomic content ratio of Si: O, which indicates a degree of oxidation, may be in a range of about 99:1 to about 33:67. As used herein, when a definition is not otherwise provided, an average particle diameter (D50) indicates a particle where an accumulated volume is about 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed, the mixing ratio may be a weight ratio in a range of about 1:99 to about 90:10.

### Binder

The binder is configured to adhere the negative electrode active material particles to each other, and to adhere the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

### Conductive Material

The conductive material is included to provide electrode conductivity, and any electrically conductive material may be included as a conductive material unless the electrically conductive material causes a chemical change. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

A content of the negative electrode active material may be in a range of about 95 wt % to about 99.5 wt % based on 100 wt % of the negative electrode active material layer, and a content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be an electrolyte solution, which may include a non-aqueous organic solvent and a lithium salt.

The non-aqueous organic solvent is configured as a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent can be included alone or in a mixture of two or more types of solvents, and when two or more types are included in a mixture, a mixing ratio can be appropriately adjusted according to the desired battery performance, which is widely known to those working in the field.

When using a carbonate-based solvent, a cyclic carbonate and a chain carbonate may be mixed and included, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed in a volume ratio in a range of about 1:1 to about 30:1.

The electrolyte solution may further include at least one of vinylethyl carbonate, vinylene carbonate, or an ethylene carbonate-based compound to improve battery cycle-life

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAICl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOP), and lithium bis(oxalato) borate (LiBOB).

A concentration of lithium salt may be within the range of about 0.1 M to about 2.0 M. When the concentration of lithium salt is within the above range, the electrolyte solution has appropriate ionic conductivity and viscosity, and thus a desired or improved performance can be achieved and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof, on one surface, or on both surfaces, of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

The thickness of the coating layer may be in a range of about 0.5 μm to about 20 μm, for example, about 1 μm to about 10 μm, or about 1 μm to about 5 μm.

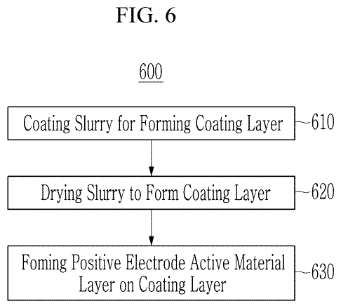

FIG. 6 is a flow chart illustrating a method for preparing a positive electrode, according to an example embodiment. In FIG. 6, the method 600 includes operation 610, which includes coating a slurry for forming a coating layer including lithium metal phosphate, boron nitride, and boehmite on a positive electrode current collector. Operation 620 includes drying the slurry to form a coating layer. Operation 630 includes forming a positive electrode active material layer on the coating layer.

Examples and comparative examples of the present disclosure are described below. However, the following examples are only examples of the present disclosure, and the present disclosure is not limited to the following examples.

### Example 1

82.7 wt % of LifePO₄ (D₅₀=1 μm), 9 wt % of hexagonal boron nitride (H—BN) (D₅₀=6 μm), 1 wt % of boehmite (D₅₀=2 μm), and 7.3 wt % of a PVDF binder were mixed in an NMP solvent to prepare a slurry for forming a coating layer. The slurry for forming a coating layer was coated on an aluminum foil current collector and dried at 110° C. in an oven to form a coating layer with a thickness of about 7.11 μm. Herein, in the coating layer, a weight ratio of boron nitride and boehmite was adjusted to be 9:1 (=h-BN: boehmite).

Subsequently, after preparing a positive electrode slurry by mixing 98.5 wt % of a positive electrode active material (LiCoO₂), 0.5 wt % of CNT (carbon nano tube), and 1 wt % of a PVDF binder in an NMP solvent, the positive electrode slurry was coated on the coating layer, and then dried and compressed to form a positive electrode active material layer with a thickness of about 30 μm, manufacturing a positive electrode.

A negative electrode slurry was prepared by mixing 97.5 wt % of a graphite negative electrode active material, 1 wt % of carboxymethyl cellulose, and 1.5 wt % of a styrene butadiene rubber in a water solvent. The negative electrode slurry was coated on a copper foil current collector, and then dried and compressed to manufacture a negative electrode.

The positive and negative electrodes were used with a polytetrafluoroethylene separator and an electrolyte solution prepared by dissolving 1 M LiPF₆ in a mixed solvent of ethylene carbonate and dimethyl carbonate in a volume ratio of 3:7 to manufacture a rechargeable lithium battery cell in a common method.

### Example 2

A positive electrode and a rechargeable lithium battery cell were manufactured substantially in the same manner as in Example 1, with a difference that the slurry for forming a coating layer was prepared by using 7 wt % of H—BN and 3 wt % of boehmite and applied to form a coating layer including boron nitride and boehmite in a weight ratio of 7:3 and had a thickness of 7.15 μm.

### Example 3

A positive electrode and a rechargeable lithium battery cell were manufactured substantially in the same manner as in Example 1, with a difference that the slurry for forming a coating layer was prepared by using 5 wt % of H—BN and 5 wt % of boehmite and applied to form a coating layer including boron nitride and boehmite in a weight ratio of 5:5 and had a thickness of 7.50 μm.

### Comparative Example 1

A positive electrode and a rechargeable lithium battery cell were manufactured substantially in the same manner as in Example 1, with a difference that the slurry for forming a coating layer was prepared by using 92.7 wt % of LifePO₄ (D₅0=1 μm) and 7.3 wt % of a PVDF binder without using boron nitride and boehmite and applied to form a coating layer having a thickness of 8.15 μm.

### Comparative Example 2

A positive electrode and a rechargeable lithium battery cell were manufactured substantially in the same manner as in Example 1, with a difference that the slurry for forming a coating layer was prepared by using 10 wt % of boron nitride without using boehmite and applied to form a coating layer having a thickness of 7.05 μm.

### Comparative Example 3

A positive electrode and a rechargeable lithium battery cell were manufactured substantially in the same manner as in Example 1, with a difference that the slurry for forming a coating layer was prepared by using 10 wt % of boehmite without using boron nitride and applied to form a coating layer having a thickness of 10.25 μm. Evaluation Example 1: Resistance Evaluation

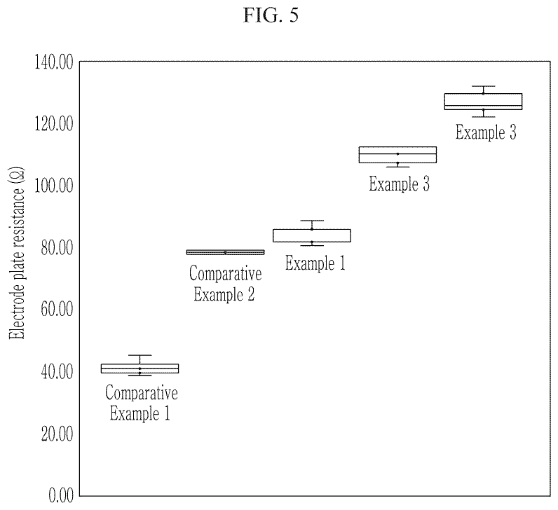

The positive electrodes according to Examples 1 to 3 and Comparative Examples 1 and 2 were evaluated with respect to electrode plate resistance by attaching an electrolyte film onto the top and bottom of each positive electrode plate and then, pressurizing them with a pressure of 40 kgf/cm² to manufacture torque cells. The cells were calculated with respect to ionic conductivity by performing electrochemical impedance electroscopy (EIS). EIS was performed at an amplitude of about 10 mV at a frequency of 0.1 Hz to 106 Hz under an air atmosphere at 45° C. A circular arc of a Nyquist plot obtained through EIS was used to obtain resistance, and the results are shown in FIG. 5.

Referring to FIG. 5, the electrode plates of Comparative Examples 1 and 2 exhibited too low an electrode plate resistance to sufficiently constitute a safety functional layer, but the electrode plates of Examples 1 to 3 exhibited an appropriately high resistance that is enough to constitute a safety functional layer, compared with the electrode plates of Comparative Example 1 and 2.

### Evaluation Example 2: Evaluation of Mixture Density and Electrode Plate Resistance

The positive electrodes according to Examples 1 to 3 and Comparative Examples 1 to 3 were measured with respect to mixture density and electrode plate resistance at an equivalent loading level, and the results are shown in Table 1 below. Herein, the loading level refers to a loading level of each coating layer, the mixture density refers to density of each coating layer, and the electrode plate resistance refers to resistance of each positive electrode, which was measured in Evaluation Example 1.

TABLE 1

| | | Mixture | |
|---|---|---|---|
| | Loading level | density | Electrode plate |
| | (mg/cm²) | (g/cc) | resistance (Ω) |
| Example 1 | 1.55 | 2.68 | 83.64 |
| Example 2 | 1.56 | 2.67 | 111.36 |
| Example 3 | 1.51 | 2.57 | 126.61 |
| Comparative Example 1 | 1.52 | 2.42 | 41.14 |
| Comparative Example 2 | 1.49 | 2.71 | 78.64 |
| Comparative Example 3 | 1.65 | 1.81 | 132.14 |

Referring to Table 1, Comparative Example 1 exhibited too low an electrode plate resistance as well as too low an obtainable mixture density at an equivalent loading level to Examples 1 to 3, which confirmed that it is unlikely that Comparative Example 1 may constitute a safety functional layer.

Comparative Example 2 might secure high mixture density at an equivalent loading level to Examples 1 to 3 but exhibited too low an electrode plate resistance of less than 80 0, which confirmed that it is unlikely that Comparative Example 2 may constitute a safety functional layer.

Comparative Example 3, at the equivalent loading level to Examples 1 to 3, might secure electrode plate resistance at a desired level but too low a mixture density, which confirmed that it is unlikely that Comparative Example 3 may achieve a high mixture density.

In comparison, Examples 1 to 3 exhibited electrode plate resistances within an appropriate or desired range of 80 0 to 130 Q, as well as a high mixture density, which confirmed that any one of Examples 1 to 3 could serve as a safety functional layer during a nail penetration or abnormal temperature rise. On the other hand, in particular, Example 2 exhibited a high mixture density as well as an electrode plate resistance within an optimal or desired range of 90 0 to 120 0, which confirmed that Example 2 could optimally or desirably constitute a safety functional layer.

### Evaluation Example 3: Nail Penetration Test

For each of the rechargeable lithium battery cell according to Examples 1 to 3 and Comparative Examples 1 to 3, 10 samples were evaluated with respect to ignition after the nail penetration, wherein the number of ignited samples was counted and provided as ignited samples/10 samples, which are shown in Table 2 below. Herein, the nail penetration was performed by preparing a nail with a diameter of 3 mm and performing the penetration at 100 mm/s.

TABLE 2

| | Penetration test result |
|---|---|
| Example 1 | 2/10 |
| Example 2 | 0/10 |
| Example 3 | 0/10 |
| Comparative Example 1 | 10/10 |
| Comparative Example 2 | 4/10 |
| Comparative Example 3 | 0/10 |

Referring to Table 2, Examples 1 to 3, as shown in Evaluation Example 1, had optimal resistance so that the coating layers effectively constitute a safety functional layer, and thus exhibited two or less ignition occurrences during the nail penetration test, securing safety.

On the other hand, Comparative Examples 1 and 2, in which a coating layer was formed, exhibited too low a resistance, as shown in Evaluation Example 1, and thus four or more ignition occurrences in the nail penetration test, which confirmed that the coating layer effectively did not constitute a safety functional layer.

On the other hand, Comparative Example 3, as shown in Evaluation Example 1, secured high resistance and thus exhibited no ignition in the nail penetration test but had too high a thickness of the coating layer, and thus exhibited too low a mixture density, which was disadvantageous in achieving capacity of the mixture layer.

### Evaluation Example 4: Charge and Discharge Characteristics Evaluation

The rechargeable lithium battery cells of Examples 1 to 3 and Comparative Example 3 were charged to an upper limit voltage of 4.5 V at a constant current of 0.2 C, and discharged to a cut-off voltage of 2.75 V at 0.2 C at 23° C. to evaluate charge and discharge characteristics, and then measured with respect to initial charge capacity, initial discharge capacity, and a ratio of the latter to the former as efficiency, which are shown in Table 3 below.

TABLE 3

| | 0.2 C charge | 0.2 C discharge | Efficiency |
|---|---|---|---|
| | (mAh) | (mAh) | (%) |
| Example 1 | 4873.153 | 4858.513 | 99.7 |
| Example 2 | 4863.355 | 4845.65 | 99.6 |
| Example 3 | 4860.42 | 4846.519 | 99.7 |
| Comparative Example 3 | 4795.16 | 4776.516 | 99.6 |

Referring to Table 3, Examples 1 to 3, compared with Comparative Example 3, exhibited desired or improved initial charge and discharge capacity.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a positive electrode current collector;
a positive electrode active material layer on the positive electrode current collector; and
a coating layer between the positive electrode current collector and the positive electrode active material layer;
wherein the coating layer includes lithium metal phosphate, boron nitride, and boehmite.

2. The positive electrode as claimed in claim 1, wherein:
the boron nitride comprises hexagonal boron nitride.

3. The positive electrode as claimed in claim 1, wherein:
a thickness of the coating layer is in a range of about 1 μm to about 30 μm.

4. The positive electrode as claimed in claim 1, wherein:
the lithium metal phosphate is included in an amount in a range of about 70 wt % to about 98 wt % based on 100 wt % of the coating layer.

5. The positive electrode as claimed in claim 1, wherein:
the boron nitride is included in an amount in a range of about 0.5 wt % to about 10 wt % based on 100 wt % of the coating layer.

6. The positive electrode as claimed in claim 1, wherein:
the boehmite is included in an amount in a range of about 0.5 wt % to about 10 wt % based on 100 wt % of the coating layer.

7. The positive electrode as claimed in claim 1, wherein:
the coating layer further comprises a binder, and
the binder comprises a fluorine-based binder.

8. The positive electrode as claimed in claim 7, wherein:
the coating layer includes about 1 wt % to about 10 wt % of the binder based on 100 wt % of the positive electrode coating layer.

9. The positive electrode as claimed in claim 1, wherein:
the coating layer includes about 10 wt % to about 90 wt % of the boron nitride, and about 10 wt % to about 90 wt % of the boehmite, based on 100 wt % of a total of the boron nitride and the boehmite.

10. The positive electrode as claimed in claim 1, wherein:
the boron nitride and the boehmite are in a particle form, and
an average particle size of the boehmite is smaller than an average particle size of the boron nitride.

11. The positive electrode as claimed in claim 10, wherein:
an average particle size of the boron nitride is in a range of about 5 μm to about 20 μm.

12. The positive electrode as claimed in claim 10, wherein:
an average particle size of the boehmite is in a range of about 0.5 μm to about 4 μm.

13. The positive electrode as claimed in claim 1, wherein:
the boron nitride and the boehmite are in a particle form, and
an average particle size of the boron nitride is in a range of about 1.25 times to about 20 times the average particle size of the boehmite.

14. The positive electrode as claimed in claim 1, wherein:
the lithium metal phosphate includes at least one compound represented by Chemical Formulas 1 to 5: 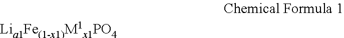
wherein, in Chemical Formula 1, 0.90≤a1≤1.5, 0≤x1≤0.4, and M¹ comprises at least one of Al, Ca, Ce, Cr, Cu, La, Mg, Mn, Mo, Nb, Ni, Sn, Sr, Ti, V, W, Y, Zn, and Zr, 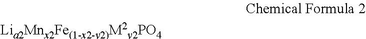
wherein, in Chemical Formula 2, 0.90≤a2≤1.5, 0.1≤x2≤0.9, 0≤y2≤0.9, and M² comprises at least one of Al, Ca, Ce, Cr, Cu, La, Mg, Mo, Nb, Ni, Sn, Sr, Ti, V, W, Y, Zn, and Zr, 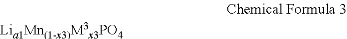
wherein, in Chemical Formula 3, 0.90≤a3≤1.5, 0≤x3≤0.4, and M³ comprises at least one of Al, Ca, Ce, Cr, Cu, La, Mg, Mo, Nb, Ni, Sn, Sr, Ti, V, W, Y, Zn, and Zr, 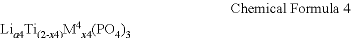
wherein, in Chemical Formula 4, 0.90≤a4≤1.5, 0≤x4≤0.4, and M⁴ comprises at least one of Al, Ca, Ce, Cr, Cu, La, Mg, Mo, Nb, Ni, Sn, Sr, V, W, Y, Zn, and Zr, 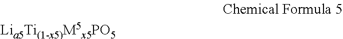
wherein, in Chemical Formula 5, 0.90≤a5≤1.5, 0≤x5≤0.4, and M⁵ comprises at least one of Al, Ca, Ce, Cr, Cu, La, Mg, Mo, Nb, Ni, Sn, Sr, V, W, Y, Zn, and Zr.

15. The positive electrode as claimed in claim 1, wherein:
a loading level of the coating layer is in a range of about 1 mg/cm² to about 5 mg/cm².

16. The positive electrode as claimed in claim 1, wherein:
the positive electrode active material layer comprises a positive electrode active material including a lithium metal composite oxide, and
the lithium metal composite oxide comprises at least one of lithium nickel-based oxide, lithium cobalt-based oxide, lithium manganese-based oxide, lithium metal phosphate, cobalt-free lithium nickel-manganese oxide, and lithium-manganese-rich oxide.

17. The positive electrode as claimed in claim 1, wherein:
a ratio of a thickness of the coating layer to a thickness of the positive electrode active material layer is in a range of about 1:2 to about 1:50.

18. The positive electrode as claimed in claim 1, wherein:
a mixture density of the positive electrode coating layer is greater than or equal to about 2.5 g/cc.

19. A method for preparing a positive electrode, the method comprising:
coating a slurry for forming a coating layer including lithium metal phosphate, boron nitride, and boehmite on a positive electrode current collector;
drying the slurry to form a coating layer; and
forming a positive electrode active material layer on the coating layer.

20. A rechargeable lithium battery, comprising
the positive electrode as claimed in claim 1;
a negative electrode; and
an electrolyte.
